(19) United States
(12) Patent Application Publication
(10) Pub. No.: US 2007/0009109 A1
(43) Pub. Date: Jan. 11, 2007

(54) Apparatus for estimating an amount of noise

(76) Inventors: Tomohiko Ise, Iwaki-city (JP); Shinichi Katsumata, Iwaki-city (JP)

Correspondence Address: BRINKS HOFER GILSON & LIONE, P.O. BOX 10395, CHICAGO, IL, 60610, US

(21) Appl. No.: 11/418,480

(22) Filed: May 4, 2006

(30) Foreign Application Priority Data
May 9, 2005 (JP) 2005-135493

(51) Int. Cl. H04B 15/00

(52) U.S. Cl. 381/94.2

(57) ABSTRACT

An apparatus for estimating an amount of noise is disclosed. The apparatus includes a FET processor that analyzes frequency components of an audio signal input to a speaker in a vehicle, a FET processor that analyzes frequency components of a signal output from a microphone in the vehicle, a coherence function calculator which detects a ratio of the audio signal included in the signal output from the microphone by calculating a magnitude squared coherence function based on the frequency components of the two signals analyzed by the first and second frequency analyzers, and a multiplier and adder which calculates an amount of external noise reaching the microphone separately from an audio sound corresponding to the audio signal on the basis of the signal output from the microphone and the ratio of the audio signal detected by the coherence function calculator.

### BACKGROUND

1. Field of the Disclosure

The present disclosure relates to an apparatus for estimating an amount of noise included in sounds collected by a microphone in a location such as a moving automobile's cabin.

2. Description of the Related Art

Sounds heard in a cabin of an automobile while the automobile is moving include a car audio system playing music and various types of noise such as road noise. Typically, the amount of noise in an automobile cabin changes greatly depending on a traveling speed of the automobile, road surface conditions, and weather conditions (such as a wind force and a rain force). Thus, assuming that the volume of the audio sound from the car audio system is constant, when there is a large amount of noise in the automobile cabin, it is often difficult to hear the audio sound produced by the car audio system. Accordingly, it would be desirable for a car audio system to automatically adjust the volume of the audio sound depending on the amount of noise in the automobile cabin. However, to automatically adjust the volume of audio sound depending on the amount of noise in the automobile cabin, the car audio system would need to accurately detect the amount of noise in the automobile cabin.

In general, a microphone can be installed in an automobile cabin to detect an amount of the noise. However, the observed sound would include the audio sound produced by the car audio system as well as the noise. Accordingly, a technique is desirable that extracts only the noise in the automobile cabin by removing the audio sound produced by the car audio system from the observed sounds. One example of a technique for removing an audio sound from observed sounds obtained by the microphone using an FIR (finite impulse response) filter to simulate in-vehicle transfer characteristics is disclosed in Japanese Unexamined Patent Application Publication No. 2001-195085, pages 2-8, FIGS. 1-7.

When the technique disclosed in Japanese Unexamined Patent Application Publication No. 2001-195085 to remove the audio sound from the observed sounds obtained by a microphone is implemented, one problem is a large processing load that occurs due to the use of an FIR filter to simulate sound-reproduction-system (in-vehicle) transfer characteristics in a signal processing system. The order of the FIR filter, which is represented by N, needs to be set to approximately 4000. For example, when N=4096, the average of the numbers of product-sum operations per sampling time of input audio data is 4096. Accordingly, to perform such a huge number of arithmetic operations, use of the technique requires the use of an expensive processor (such as a central processing unit or digital signal processor), resulting in an expensive car audio system. Another problem associated with the technique disclosed in Japanese Unexamined Patent Application Publication No. 2001-195085 is that sound-reproduction-system transfer characteristics are not stationary but change with time. Therefore, it is necessary to sequentially update an FIR filter coefficient, which requires an increase in the amount of operations a process must perform. Considering the amount of processing necessary for these operations (e.g., updating of a filter coefficient by using an adaptive algorithm), it will be appreciated that implementation of the technique requires an expensive processor capable of processing a large number of operations, further increasing the costs of a car audio system.

### BRIEF SUMMARY

The present disclosure is made in view of the above-described circumstances, and it is an object of the present disclosure to provide an apparatus for estimating an amount of noise which has a reduced processing load and in which reduction in cost has been achieved.

To solve the above-described problems, according to an aspect of the present disclosure, an apparatus for estimating the amount of noise is provided which includes a first frequency component analyzer which analyzes frequency components of an audio signal input to a speaker provided in a vehicle, a second frequency component analyzer which analyzes frequency components of a signal output from a microphone provided in the vehicle, a coherence function calculator which detects the ratio of the audio signal included in the signal output from the microphone by calculating a magnitude squared coherence function based on the frequency components of the two signals analyzed by the first and second frequency analyzers, and a noise calculator which calculates the amount of external noise reaching the microphone separately from an audio sound corresponding to the audio signal on the basis of the signal output from the microphone and the ratio of the audio signal detected by the coherence function calculator.

Accordingly, using a predetermined arithmetic expression in the apparatus to estimate noise by performing a magnitude squared coherence function for two types of signals reduces the number of arithmetic operations compared to using an FIR filter to estimate noise in which product-sum calculations are repeatedly performed. The reduced number of arithmetic operations makes it possible to use a less expensive processor having low processing capabilities, thereby reducing costs.

Preferably, the apparatus for estimating the amount of noise further includes a power spectrum calculator which calculates a power spectrum for each frequency component analyzed by the second frequency component analyzer, and a multiplier which calculates a power spectrum of the audio signal by multiplying the power spectrum calculated by the power spectrum calculator by the ratio of the audio signal detected by the coherence function calculator.

This enables estimating the amount of external noise and acquiring a power spectrum of an audio signal separately from the external noise.

The noise calculator may calculate a power spectrum of the external noise as the amount of the external noise by subtracting the power spectrum of the audio signal calculated by the multiplier from the power spectrum calculated by the power spectrum calculator. This enables obtaining, as the amount of noise, a power spectrum of external noise. Therefore, various types of processing using the obtained power spectrum of the external noise, such as gain correction of an audio signal, can easily be realized.

### BRIEF DESCRIPTION OF THE DRAWINGS

FIG. 1 is a block diagram showing one embodiment of a configuration of an apparatus for estimating an amount of noise;

FIG. 2 is a block diagram of one embodiment of an example of a configuration of an audio signal correcting system including the apparatus shown in FIG. 1;

FIG. 3 is an illustration modeling a relationship between signals input to and output from an in-vehicle acoustic transfer system, where H(k) represents a transfer function of the acoustic transfer system;

FIG. 4 is a graph showing one result of a simulation of an amount of noise using the apparatus shown in FIG. 1;

FIG. 5 is a graph showing another result of a simulation of an amount of noise using the apparatus shown in FIG. 1; and

FIG. 6 is a graph showing another result of a simulation of an amount of noise using the apparatus shown in FIG. 1.

### DETAILED DESCRIPTION OF THE DRAWINGS

An apparatus (amount-of-noise estimating apparatus) 100 for estimating the amount of noise in accordance with an embodiment of the present disclosure is described below with reference to the accompanying drawings.

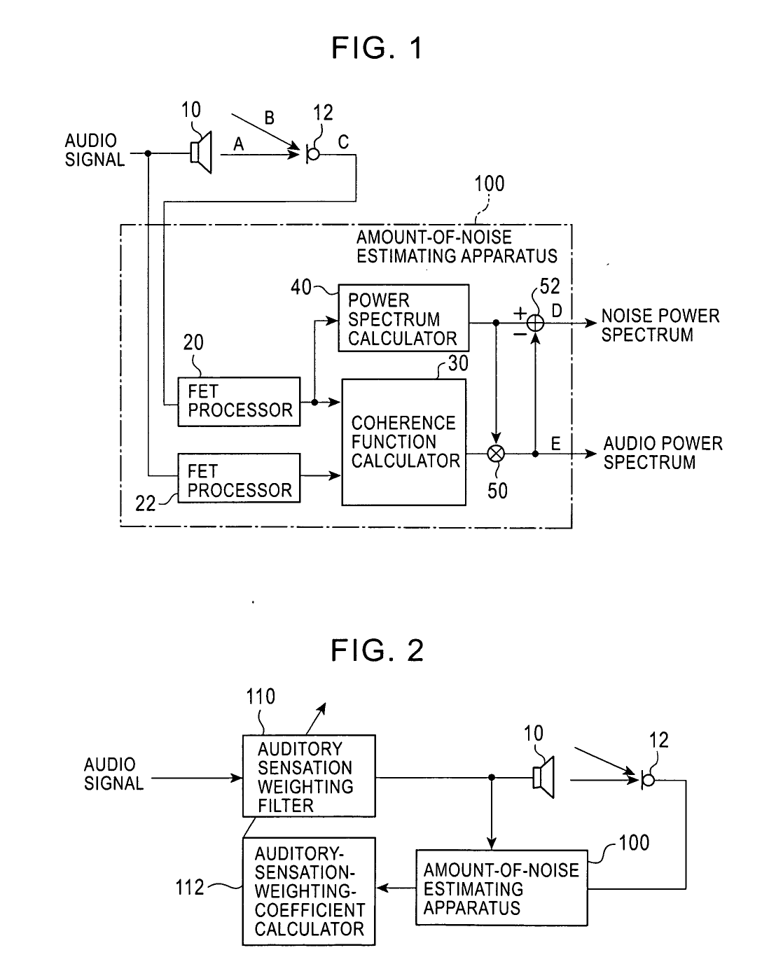

FIG. 1 is a block diagram showing one embodiment of a configuration of an amount-of-noise estimating apparatus 100. The amount-of-noise estimating apparatus 100 shown in FIG. 1 performs an operation in which, when audio sound A corresponding to an audio signal is output from a speaker 10 installed in a vehicle, a power spectrum of external noise B included in sounds collected by a microphone 12 installed in the vehicle is estimated as the amount of noise. Accordingly, the amount-of-noise estimating apparatus 100 includes two FET (fast Fourier transform) processors 20 and 22, a coherence function calculator 30, a power spectrum calculator 40, a multiplier 50, and an adder 52.

In performing a FET calculation to analyze frequency components, one FET processor 20 calculates a complex spectrum for each frequency component of a signal (hereinafter referred to as an “observed signal”) output from the microphone 12. Similarly, in performing a FET calculation to analyze frequency components, the other FET processor 22 calculates a complex spectrum for each frequency component of an audio signal input to the speaker 10.

The coherence function calculator 30 calculates a magnitude squared coherence function by using the two complex spectra calculated by the two FET processors 20 and 22. This magnitude squared coherence function represents, for each frequency component, a ratio of an audio signal included in the observed signal output from the microphone 12. For example, when the value of the calculated magnitude squared coherence function is 0.8, the observed signal output from the microphone 12 indicates a ratio of power of components based on the audio signal is 80%, with the remaining 20% representing the external noise components which are uncorrelated with the audio signal.

On the basis of the complex spectrum of the observed signal calculated by the FET processor 20, the power spectrum calculator 40 calculates a power spectrum of the observed signal for each frequency component. The multiplier 50 calculates a power spectrum (audio power spectrum E) of the audio signal in the observed signal by multiplying the power spectrum of the observed signal calculated by the power spectrum calculator 40 by the value of the magnitude squared coherence function calculated by the power spectrum calculator 40. This multiplication is performed for each frequency component. By subtracting the power spectrum of the audio signal calculated by the multiplier 50 from the power spectrum of the observed signal calculated by the power spectrum calculator 40, the adder 52 calculates a power spectrum (noise power spectrum D) of external noise in which components corresponding to the audio signal are removed from the observed signal.

The FET processor 22 corresponds to a first frequency component analyzer. The FET processor 20 corresponds to a second frequency component analyzer. The coherence function calculator 30 corresponds to a coherence function calculator. The multiplier 50 and the adder 52 correspond to a noise calculator. The power spectrum calculator 40 corresponds to a power spectrum calculator. The multiplier 50 corresponds to a multiplier.

FIG. 2 shows one embodiment of an example to which the amount-of-noise estimating apparatus 100 shown in FIG. 1 is applied, and is a block diagram showing one embodiment of an example of a configuration of an audio signal correcting system including the amount-of-noise estimating apparatus 100. The audio signal correcting system shown in FIG. 2 has a configuration in which an auditory sensation weighting filter 110 and an auditory sensation weighting coefficient calculator 112 are added to the configuration shown in FIG. 1 comprising the amount-of-noise estimating apparatus 100, the speaker 10, and the microphone 12.

The auditory sensation weighting filter 110 may be an FIR filter that adjusts characteristics of the input audio signal. The auditory sensation weighting coefficient calculator 112 sets a filter coefficient of the auditory sensation weighting filter 110 on the basis of the power spectrum for each frequency component of the external noise which is estimated by the amount-of-noise estimating apparatus 100. For example, the filter coefficient of the auditory sensation weighting filter 110 may be set so that, when the power spectrum for each frequency component of the external noise increases, the corresponding gain of the frequency component increases. In addition, instead of performing a gain adjustment for a change in external noise, the auditory sensation weighting coefficient calculator 112 may set the filter coefficient of the auditory sensation weighting filter 110 based on a correcting gain characteristic that represents how much the gain needs to be increased for an audio signal obtained in silence so that sound corresponding to an audio signal obtained in the presence of noise can be heard as sound similar in magnitude to the sound in silence and the amount of noise estimated by the amount-of-noise estimating apparatus 100. One method for setting the correcting gain of the audio signal, as described above, is disclosed in Japanese Unexamined Patent Application Publication No. 2001-136039.

A basic principle of estimating an amount of noise of external noise by using the coherence function calculator 30 is described below.

1. Estimation of Transfer Function when There is a Source of Noise at Output End

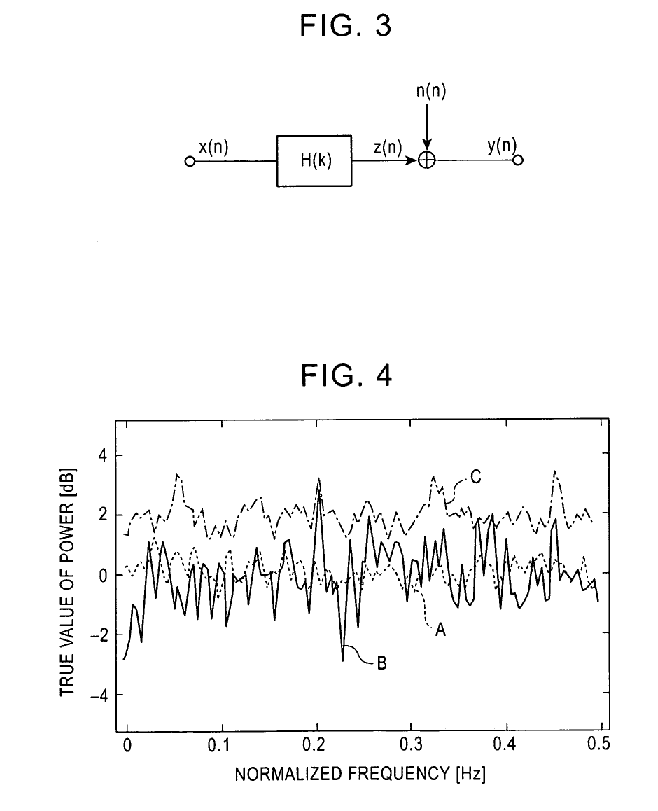

FIG. 3 is an illustration modeling a relationship between signals input to and output from an in-vehicle acoustic transfer system, where H(k) represents a transfer function of the acoustic transfer system. As shown in FIG. 3, at an output end (the microphone 12 in the system shown in FIG. 1) of the acoustic transfer system, noise component (external noise) n(n) that is uncorrelated to input x(n) is added to output z(n) of transfer function H(k) for input x(n). The sum y(n) of both serves as a signal that can actually be observed. At this time, the input-output relationship is represented by the following expression. In the following expression, operator “*” represents convolution.

$$\begin{matrix}y ( n ) = z ( n ) + n ( n ) \\ = h ( n ) * x ( n ) + n ( n )\end{matrix} \qquad ( 1 )$$

Assuming that x(n) and y(n) have been obtained and acoustic transfer system H(k) is stationary, estimation of acoustic transfer system H(k) by using the cross-spectral method is performed.

Input signal x(n) and output signal y(n) are divided into M blocks {xᵢ(n)} and {yᵢ(n)} (i=0, 1, 2, . . . , M), each consisting of N points. When spectra of the input and output signal blocks are represented by Xᵢ(k) and Yᵢ(k), the input-output relationship of the acoustic transfer system can be represented by the following expression in a frequency domain. In addition, similarly, a spectrum of the i-th noise signal {nᵢ(n)} is represented by Nᵢ(k).
Yᵢ(k)=H(k)Xᵢ(k)+Nᵢ(k) (2)

The following expression (3) represents the square of a difference, represented by average “error²”, concerning power “i” of a difference between a response, represented by Zᵢˆ(k)=H(k)Xᵢ(k), of an acoustic transfer system including no noise, the response being estimated from input Xᵢ(k) and transfer function H(k), and actual output Yᵢ(k). In this specification, the symbol “ˆ” cannot be shown in a form overlaid on a character. Accordingly, this symbol is shown, with it shifted rightward. In the following expression, the superscript “*” represents complex conjugation, and Eᵢ[ ] represents addition and averaging.

$$\begin{matrix}{error}^{2} = {E}_{i} [ {\vert {Y}_{i} ( k ) - {\hat{Z}}_{i} ( k ) \vert}^{2} ] \\ = {E}_{i} [ {\vert {Y}_{i} ( k ) - H ( k ) {X}_{i} ( k ) \vert}^{2} ] \\ = {E}_{i} [ {\vert {Y}_{i} ( k ) \vert}^{2} ] - {E}_{i} [ {Y}_{i} ( k ) {H}^{*} ( k ) {X}_{i}^{*} ( k ) ] - {E}_{i} [ {Y}_{i}^{*} ( k ) H ( k ) {X}_{i} ( k ) ] + \\ {E}_{i} [ {\vert H ( k ) {X}_{i} ( k ) \vert}^{2} ]\end{matrix} \qquad ( 3 )$$

By partially differentiating error² concerning H(k), and setting the result to zero, the following expression is obtained.
Eᵢ[|Xᵢ(k)|²]H(k)−Eᵢ[Xᵢ*(k)Yᵢ*(k)]=0 (4)

From the above result, optimal estimated value H(k)ˆ of transfer function H(k) at which the average of estimated error power values is minimum, and estimated response value Zᵢ(k)ˆ of the acoustic transfer system including no noise are given as follows:

$$\begin{matrix}\hat{H} ( k ) = \frac{{E}_{i} [ {X}_{i}^{*} ( k ) {Y}_{i} ( k ) ]}{{E}_{i} [ {\vert {X}_{i} ( k ) \vert}^{2} ]} & ( 5 ) \\ {\hat{Z}}_{i} ( k ) = \hat{H} ( k ) {X}_{i} ( k ) & ( 6 )\end{matrix}$$

2. Magnitude Squared Coherence Function

The ratio |γ(k)|² between the average of power spectra of a response including no noise component and the average of power spectra of a response including noise is represented by the following expression.

$$\begin{matrix}{\vert γ ( k ) \vert}^{2} = \frac{{E}_{i} [ {\vert {\hat{Z}}_{i} ( k ) \vert}^{2} ]}{{E}_{i} [ {\vert {Y}_{i} ( k ) \vert}^{2} ]} \\ = \frac{{E}_{i} [ {\vert \hat{H} ( k ) {X}_{i} ( k ) \vert}^{2} ]}{{E}_{i} [ {\vert {Y}_{i} ( k ) \vert}^{2} ]} \\ = {\vert \hat{H} ( k ) \vert}^{2} \frac{{E}_{i} [ {\vert {X}_{i} ( k ) \vert}^{2} ]}{{E}_{i} [ {\vert {Y}_{i} ( k ) \vert}^{2} ]} \\ = {\vert \frac{{E}_{i} [ {X}_{i}^{*} ( k ) {Y}_{i} ( k ) ]}{{E}_{i} [ {\vert {X}_{i} ( k ) \vert}^{2} ]} \vert}^{2} \frac{{E}_{i} [ {\vert {X}_{i} ( k ) \vert}^{2} ]}{{E}_{i} [ {\vert {Y}_{i} ( k ) \vert}^{2} ]} \\ = \frac{{\vert {E}_{i} [ {X}_{i}^{*} ( k ) {Y}_{i} ( k ) ] \vert}^{2}}{{E}_{i} [ {\vert {X}_{i} ( k ) \vert}^{2} ] {E}_{i} [ {\vert {Y}_{i} ( k ) \vert}^{2} ]}\end{matrix} \qquad ( 7 )$$

The value |γ(k)|² is called a magnitude squared coherence function. The function |γ(k)|² has a value between 0 and 1. The magnitude squared coherence function represents the ratio of power of components in an output sequence that has linear relationships with an input sequence. For example, the representation “|γ(k)|²=0.8” indicates that, in an output, the power of components based on an input is 80% and the remaining 20% represents noise components (uncorrelated with the input) that cannot be described on the basis of linear transfer of the input.

3. Estimation of Average Power of Noise Components by Using Magnitude Squared Coherence

As described above, the magnitude squared coherence function represents the ratio of power of components in an output sequence that have linear relationships with an input sequence. By using the magnitude squared coherence function, the power of noise components that may be mixed with an output of an acoustic transfer system can be estimated.

By using estimated value H(k)ˆ of the transfer function in expression (5), the minimum value of the power of estimated error of the transfer function is represented by the following expression.

$$\begin{matrix}\begin{matrix}{error}_{min} = {E}_{i} [ {\vert {Y}_{i} ( k ) \vert}^{2} ] - \hat{H} * ( k ) {E}_{i} [ {\vert {Y}_{i} ( k ) {X}_{i}^{*} ( k ) \vert}^{2} ] - \\ \hat{H} ( k ) {E}_{i} [ {Y}_{i}^{*} ( k ) {X}_{i} ( k ) ] + {\vert \hat{H} ( k ) \vert}^{2} {E}_{i} [ {\vert {X}_{i} ( k ) \vert}^{2} ] \\ = {E}_{i} [ {\vert {Y}_{i} ( k ) \vert}^{2} ] + {\hat{H}}^{*} ( k ) \{ \hat{H} ( k ) {E}_{i} [ {\vert {X}_{i} ( k ) \vert}^{2} ] - \\ {E}_{i} [ {Y}_{i}^{*} ( k ) {X}_{i} ( k ) ] \} - \hat{H} ( k ) {E}_{i} [ {X}_{i} ( k ) {Y}_{i}^{*} ( k ) ] \\ = {E}_{i} [ {\vert {Y}_{i} ( k ) \vert}^{2} ] - \frac{{\vert {E}_{i} [ {X}_{i}^{*} ( k ) {Y}_{i} ( k ) ] \vert}^{2}}{{E}_{i} [ {\vert {X}_{i} ( k ) \vert}^{2} ]}\end{matrix} & ( 8 ) \\ = {E}_{i} [ {\vert {Y}_{i} ( k ) \vert}^{2} ] ( 1 - {\vert γ ( k ) \vert}^{2} ) & ( 9 )\end{matrix}$$

The above value “errorₘᵢₙ” corresponds to average power |Nᵢ(k)|² of noise that is uncorrelated with the input. When γ(k)=1, the input and the output are completely correlated with each other, and the power of noise is zero. Conversely, when γ(k)=0, the input and the output are not completely correlated with each other, and output power Eᵢ[Yᵢ(k)] is equal to noise power |Nᵢ(k)|. This indicates that the average power of noise components being mixed with an output of an acoustic transfer system can be found from input and output sequences in a system.

FIGS. 4 to 6 are graphs showing simulation results obtained when the amount-of-noise estimating apparatus 100 shown in FIG. 1 is used to estimate the amount of noise. Marks A to E in FIGS. 4 to 6 correspond to the marks A to E shown in FIG. 1, respectively. The audio sound output from the speaker 10 is denoted by mark A. The external noise is denoted by mark B. The observed signal output from the microphone 12 is denoted by mark C. Noise power spectrum is denoted by mark D. Audio power spectrum is denoted by mark E.

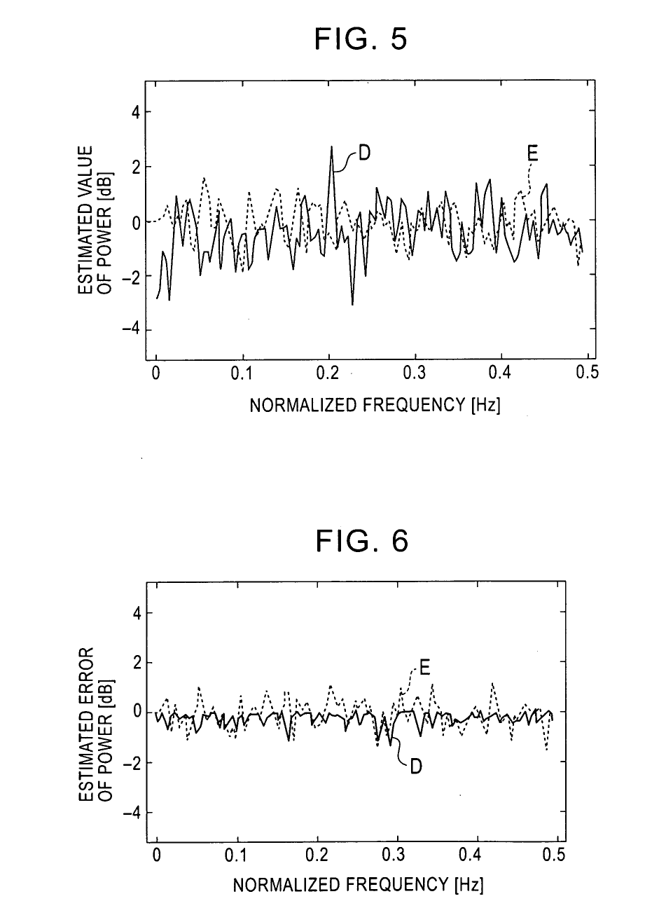

FIG. 4 shows the true values of power for each frequency component of audio sound A, external noise B, and observed signal C. FIG. 5 shows estimated values of noise power spectrum D and audio power spectrum E calculated by the magnitude squared coherence function. FIG. 6 shows the values of errors included in noise power spectrum D and audio power spectrum E. As shown in FIGS. 4 to 6, it is found that, by using the magnitude squared coherence function, the amount (noise power spectrum) of noise can be estimated with high accuracy.

As described above, in the amount-of-noise estimating apparatus 100 according to this embodiment, expression (7) is used to calculate a magnitude squared coherence function for two types of signals. Thus, the number of arithmetic operations can be reduced compared with processing in which a plural number of product-sum operations with an FIR filter are performed. Specifically, when the number of data items is N, the number of product-sum operations for calculation using expression (7) is as follows:
2×N+2×N log₂N+4×(N/2)+2×2×(N/2)+2×(N/2)+(N/2)+2×24×(N/2)=2N log₂N+31.5N

For example, when N=4096, from the above expression, the average number of product-sum operations per sampling time is (2Nlog₂N+31.5N)/N=2log₂4096+31.5=55.5. An average number of product-sum operations of 55.5 is 1/74 the number of data items (4096), reducing the number of arithmetic operations a system must perform. It will be appreciated that a reduced number of arithmetic operations allows a system to use a less-expensive processor having lesser processing capabilities to reduce the cost of a car audio system.

The present disclosure is not limited to the above-described embodiment and may be modified to be within the scope of the present disclosure. For example, although in the above-described embodiment, a FET calculation is used to analyze signal frequencies, frequency components may additionally be analyzed using a filter bank including a plurality of bandpass filters for extracting frequency components. It is therefore intended that the foregoing detailed description be regarded as illustrative rather than limiting, and that it be understood that it is the following claims, including all equivalents, that are intended to define the spirit and scope of the invention.

1. An apparatus for estimating an amount of noise, comprising:
a first frequency component analyzer which analyzes frequency components of an audio signal input to a speaker in a vehicle;
a second frequency component analyzer which analyzes frequency components of a signal output from a microphone in the vehicle;
a coherence function calculator which detects a ratio of the audio signal included in the signal output from the microphone to the signal output from the microphone by calculating a magnitude squared coherence function based on the frequency components of the two signals analyzed by the first and second frequency analyzers; and
a noise calculator which calculates an amount of external noise reaching the microphone separately from an audio sound corresponding to the audio signal reaching the microphone, the calculation based on the signal output from the microphone and the ratio detected by the coherence function calculator.

2. The apparatus according to claim 1, further comprising:
a power spectrum calculator which calculates a power spectrum for each frequency component analyzed by the second frequency component analyzer; and
a multiplier which calculates a power spectrum of the audio signal by multiplying the power spectrum calculated by the power spectrum calculator by the ratio detected by the coherence function calculator.

3. The apparatus according to claim 2, wherein the noise calculator calculates a power spectrum of the external noise as the amount of the external noise by subtracting the power spectrum of the audio signal calculated by the multiplier from the power spectrum calculated by the power spectrum calculator.

4. A method for estimating an amount of noise, comprising:
analyzing frequency components of an audio signal input to a speaker in a vehicle;
analyzing frequency components of a signal output from a microphone in the vehicle;
detecting a ratio of the audio signal included in the signal output from the microphone to the signal output from the microphone by calculating a magnitude squared coherence function based on the frequency components of the two signals analyzed in the first and second steps; and
calculating an amount of external noise reaching the microphone separately from an audio sound corresponding to the audio signal, the calculation based on the signal output from the microphone and the detected ratio.

5. The method according to claim 4, further comprising:
calculating a power spectrum for each analyzed frequency component of the signal output from the microphone; and
calculating a power spectrum of the audio signal by multiplying the calculated power spectrum for each analyzed frequency component of the signal output from the microphone by the detected ratio.

6. The method according to claim 5, wherein the step of calculating the amount of external noise comprises:
calculating a power spectrum of the external noise as the amount of external noise by subtracting the power spectrum of the audio signal from the power spectrum for each analyzed frequency component of the signal output from the microphone.

7. A computer-readable storage medium comprising a set of instructions to direct a computer to perform acts of:
analyzing frequency components of an audio signal input to a speaker in a vehicle;
analyzing frequency components of a signal output from a microphone in the vehicle;
detecting a ratio of the audio signal included in the signal output from the microphone to the signal output from the microphone by calculating a magnitude squared coherence function based on the frequency components of the two signals analyzed in the first and second steps; and
calculating an amount of external noise reaching the microphone separately from an audio sound corresponding to the audio signal, the calculation based on the signal output from the microphone and the detected ratio.

8. The computer-readable storage medium of claim 7, further comprising a set of instructions to direct a computer to perform acts of:
calculating a power spectrum for each analyzed frequency component of the signal output from the microphone; and
calculating a power spectrum of the audio signal by multiplying the calculated power spectrum for each analyzed frequency component of the signal output from the microphone by the detected ratio.

9. The computer-readable storage medium of claim 8, wherein calculating the amount of external noise comprises:
calculating a power spectrum of the external noise as the amount of external noise by subtracting the power spectrum of the audio signal from the power spectrum for each analyzed frequency component of the signal output from the microphone.
